(19) United States
(12) Patent Application Publication
(10) Pub. No.: US 2006/0250803 A1
(43) Pub. Date: Nov. 9, 2006

(54) Street light with heat dispensing device

(76) Inventor: Chia-Yi Chen, Donggang Township (TW)

Correspondence Address: CHARLES E. BAXLEY, ESQ., 90 JOHN STREET, THIRD FLOOR, NEW YORK, NY, 10038, US

(21) Appl. No.: 11/122,486

(22) Filed: May 4, 2005

(51) Int. Cl. F21V 29/00; F21L 13/00; F21L 4/00

(52) U.S. Cl. 362/373; 362/183

(57) ABSTRACT

A street light includes a base and a light source such as LEDs is connected to a heat dispensing device which is connected to the base. A cover is connected to the base and the at least one light source is located between the base and the cover. A plurality of fins are connected to a top of the base.

### FIELD OF THE INVENTION

The present invention relates to a street light that has heat dispensing device so as to quickly release heat from the light bulb.

### BACKGROUND OF THE INVENTION

A conventional street light generally includes uses a light bulb which is enclosed by a glass or plastic cover. However, the conventional light bulb consumes tremendous electric power and cannot used with polar energy equipment. Besides, the enclosed space cannot dispense heat efficiently so that the light bulb tends to be burned within a short period of time. Furthermore, if the light bulbs are replaced with Liquid Emitting Diodes, the high temperature is trapped in the enclosed space and that shortens the life of use of the Liquid Emitting Diodes.

The present invention intends to provide a street light that has heat dispensing device for quickly releasing the heat form the light bulb.

### SUMMARY OF THE INVENTION

The present invention relates to a street light which comprises a base and at least one light source is connected to a heat dispensing device which is connected to the base. A cover is connected to the base and the at least one light source is located between the base and the cover. A plurality of fins are connected to a top of the base.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view of the street light of the present invention;

FIG. 2 is a perspective view of the street light of the present invention;

FIG. 3 shows another embodiment of the street light of the present invention;

FIG. 4 shows another embodiment of the street light of the present invention, and

FIG. 5 shows yet another embodiment of the street light of the present invention.

### DETAILED DESCRIPTION OF THE PREFERRED EMBODIMENT

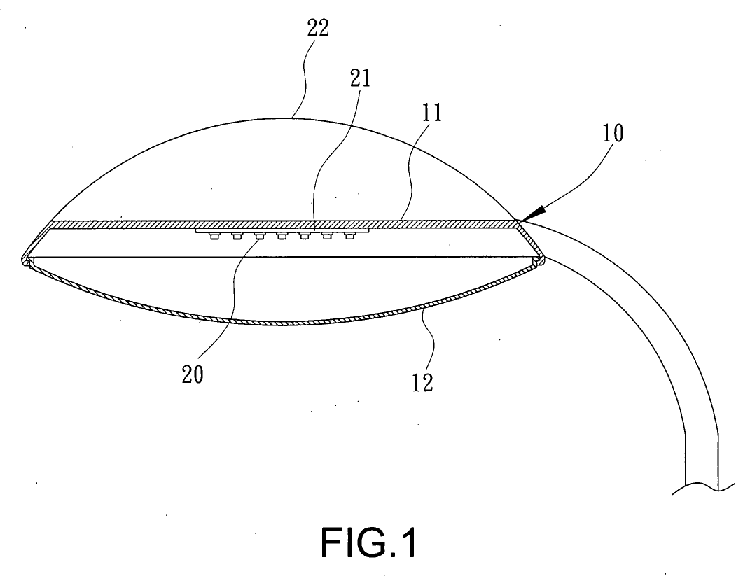

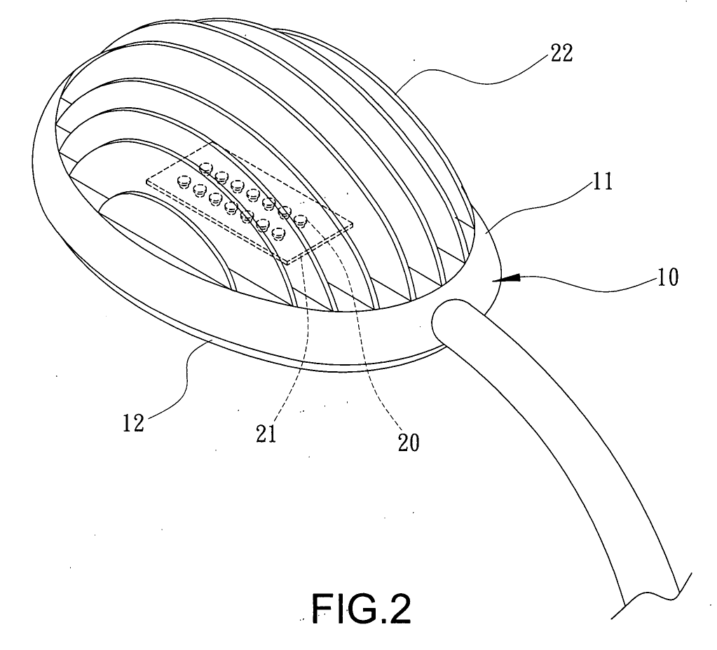

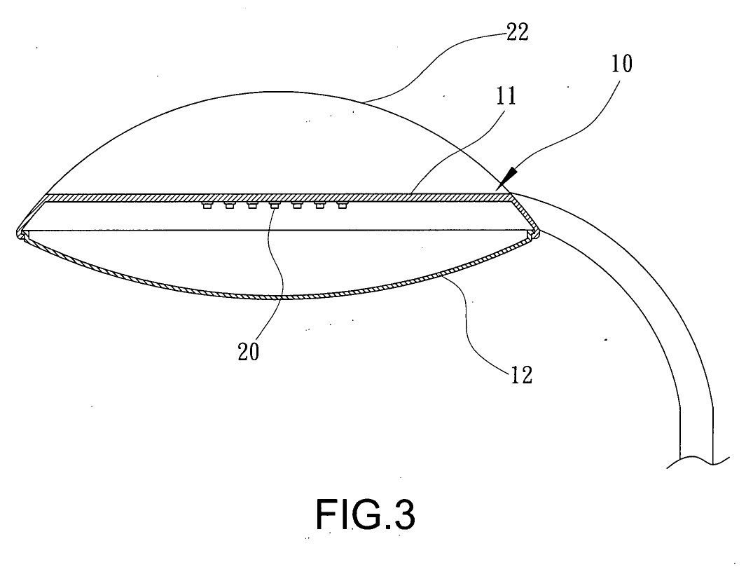

Referring to FIGS. 1 and 2, the street light 10 of the present invention comprises a base 11 and a heat dispensing device 21 which is connected to the base 11. At least one light source 20 such as Liquid Emitting Diodes is connected to the heat dispensing device 21. A cover 12 is connected to the base 11 and the light source 20 is located between the base 11 and the cover 12. A plurality of fins 22 are integrally connected to a top of the base 31 such that the heat from the light source 20 escapes from the fins 22 and the heat dispensing device 21. The fins 22 and the heat dispensing device 21 are made by aluminum or the like to quickly release the heat into the air. As shown in FIG. 3, the at least one light source 20 can also be directly connected to the base 11.

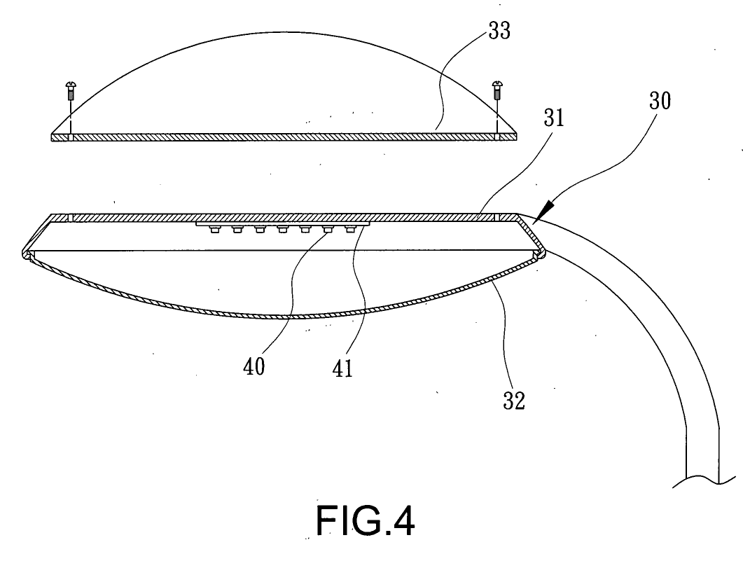

FIG. 4 shows another embodiment of the street light 30, wherein the at least one light source 40 is connected to the heat dispensing device 41 which is fixed to the base 31 and the cover 32 is connected to the base 31. Fins 33 are connected to the base 31 by screws.

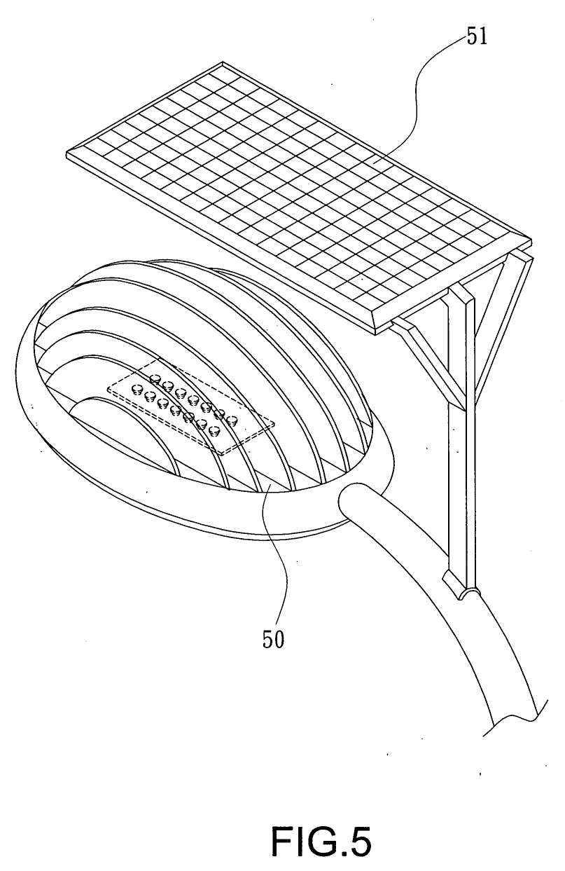

FIG. 5 shows that a solar energy board 51 is supported by a frame which is fixed on the post of the street light and the solar energy board 51 is located above the base 50. The solar energy board 51 may also cooperated with a battery to generate electric power for providing electric power to the at least one light source 20.

While we have shown and described the embodiment in accordance with the present invention, it should be clear to those skilled in the art that further embodiments may be made without departing from the scope of the present invention.

What is claimed is:

1. A street light comprising:
a base;
at least one light source connected to a heat dispensing device which is connected to the base;
a cover connected to the base and the at least one light source located between the base and the cover, and
a plurality of fins connected to a top of the base.

2. The street light as claimed in claim 1, wherein a solar energy board is located above the base.

3. A street light comprising:
a base;
at least one light source connected to the base;
a cover connected to the base and the at least one light source located between the base and the cover, and
a plurality of fins connected to a top of the base.

4. The street light as claimed in claim 3, wherein a solar energy board is located above the base.
